(19) United States
(12) Patent Application Publication
(10) Pub. No.: US 2008/0230461 A1
(43) Pub. Date: Sep. 25, 2008

(54) Filter Press with Novel Filter Pack Clamping Arrangement

(76) Inventors: Horst Christian Schulte, Johannesburg (ZA); Percy Forssman, Pretoria (ZA)

Correspondence Address: NATH & ASSOCIATES, 112 South West Street, Alexandria, VA, 22314, US

(21) Appl. No.: 11/918,409

(22) PCT Filed: Apr. 3, 2006
(86) PCT No.: PCT/IB2006/050996

§ 371 Date: May 7, 2008

(30) Foreign Application Priority Data
Apr. 4, 2005 (ZA) 2005/02697

(51) Int. Cl. B01D 25/164; B01D 25/19

(52) U.S. Cl. 210/231

(57) ABSTRACT

The invention provides a novel filter press comprising: a support frame; a plurality of filter plates mounted adjacent one another on the support frame, the filter plates being displaceable between an inoperative position wherein adjacent filter plates are spaced apart, and an operative position wherein adjacent filter plates abut to form filtration cavities between abutting filter plates; a backing arrangement located adjacent an outermost filter plate, the backing arrangement being displaceable relative to the support frame and being releasably lockable in a fixed position relative to the support frame; and a pressure exerting mechanism adapted to force the filter plates in co-operation with the backing arrangement into sealing abutment when the filter plates are in an operative position and the backing arrangement is releasably locked relative to the support frame.

### FIELD OF THE INVENTION

The invention relates to a filter press, and more particularly, but not exclusively to a filter press having a novel arrangement for clamping filter plates of the filter press.

### BACKGROUND TO THE INVENTION

Filter presses are generally used to separate solids from liquids, and more particularly to separate a suspension such as slurry into solids and solid-free filtrate by forcing the suspension against a filter cloth that only allows liquid to permeate through it in the form of solid-free filtrate.

A filter press in essence comprises a plurality of filter plates mounted adjacent one another, the filter plates being moveable between an operative position wherein adjacent filter plates abut, and an inoperative position wherein adjacent filter plates are spaced apart. The filter plates are geometrically shaped to define filtration cavities when adjacent filter plates abut. The filter plates have internal inlet conduits for feeding slurry into the filtration cavities, and internal outlet conduits for discharging solid-free filtrate from the filtration cavities. Filter cloths, designed to allow permeation of liquids therethrough, separate the filtration cavities from the internal outlet conduits.

In use the filtration cavities are filled under pressure with a suspension to be separated or filtrated. The liquid portion of the suspension permeates through the filter cloth, and is discharged through the internal outlet conduits. The solid particles remain trapped in the filtration chamber, and accumulate against the filter cloth to form densely packed layer of solid material commonly referred to as a filter cake.

The filter cloth has an inherent flow resistance, which is overcome by providing an initial pressure differential across the filter cloth. As the solids accumulate against the filter cloth to form a solid layer, more pressure is required to overcome the flow resistance. The feed pressure is thus increased until a maximum operating pressure is reached, at which pressure most of the liquid has permeated through the filter cloth, and the layer of solids has been compacted to form a densely packed filter cake.

It will be appreciated that the high pressures in the filtration cavities result in parting forces being exerted on adjacent filter plates. In order to maintain a proper seal between plates, and thus to prevent the plates from being displaced away form one another, an opposing closing force is required to counteract the parting forces. The closing force is typically provided by way of a hydraulic piston and cylinder arrangement that exerts a force on the outermost filter plate to maintain all the filter plates in sealing abutment during operation of the filter press. The diameter and thus cross-sectional area of the piston is however substantially smaller than the area of the filter plates, and more particularly the pressurized area of the filtration cavities defined between adjacent filter plates, and very high piston pressure is therefore required to exert sufficient force on the filter plates. The required closing force results in the piston and cylinder arrangement being bulky and expensive, and a high-pressure hydraulic supply is required to provide sufficient hydraulic pressure when actuating the piston.

A further disadvantage associated with piston operated filter presses is that the piston is typically used to move the filter plates between operative and inoperative positions in addition to providing the closing force as described above. The piston arrangement therefore needs to have a long stroke to allow the filter plates to be sufficiently spaced apart when in the inoperative position, which increases the length of the piston arrangement, and therefore also the length and space requirement of the filter press.

As described above, it is an important requirement of filter press operation that the filter plates must be displaceable between an operative position wherein adjacent pressure plates abut, and an inoperative position wherein adjacent pressure plates are spaced apart. In order to allow movement between the filter plates and the support frames on which they are located, mounting extensions in the form of brackets are typically provided on sides of the filter plates, and are configured to rest on upper surfaces of the support frame. When a force is exerted on the pressure plates, the plates slide on the brackets along the support frame. It will however be appreciated that such a configuration results in excessive friction, and that considerable force may be required to move the filter plates.

### OBJECT OF THE INVENTION

It is accordingly an object of the invention to provide a filter press which will, at least partially, alleviate the disadvantages mentioned above, and/or which will provide a useful alternative to existing filter presses.

### SUMMARY OF THE INVENTION

According to the invention there is provided a filter press comprising:
a support frame;
a plurality of filter plates mounted adjacent one another on the support frame, the filter plates being displaceable between an inoperative position wherein adjacent filter plates are spaced apart, and an operative position wherein adjacent filter plates abut to form filtration cavities between abutting filter plates;
   a backing arrangement located adjacent an outermost filter plate,
the backing arrangement being displaceable relative to the support frame and being releasably lockable in a fixed position relative to the support frame;
   a pressure exerting mechanism adapted to force the filter plates in co-operation with the backing arrangement into sealing abutment when the filter plates are in an operative position and the backing arrangement is releasably locked relative to the support frame.

The pressure exerting mechanism may be a pressure cell, and may be one or more pressurizable bladders.

The bladder may be of reinforced plastic or rubber and pressurized hydraulically or pneumatically.

The backing arrangement may comprise first and second backing plates, with the pressure exerting mechanism being sandwiched there between.

The first backing plate is releasably lockable to the support frame, and the second backing plate is moveable relative to the first backing plate so that the second backing plate is forced away from the first backing plate when the pressure exerting mechanism is pressurized, so as to exert a force on the filter plates to move and hold the filter plates to and in the operative position.

The cross-sectional areas of the backing plates and of the bladder are preferably of similar size or larger than the cross-sectional area of the filtration cavities formed by abutting filter plates.

The first backing plate may be releasably locked to the support frame by means of a locking member being laterally moveably connected to the first backing plate for engaging an aperture provided in the support frame.

Alternatively the locking member may be laterally moveably connected to the support frame for engaging an aperture provided in the first backing plate.

The locking member may be in the form of a bolt.

The locking member may be moved between a locked position and an unlocked position by means of a piston and cylinder arrangement.

The backing arrangement may be connected to the filter plates in order for the filter plates to be displaced when the backing arrangement is displaced relative to the support frame.

The backing arrangement is preferably connected to the outermost filter plate by means of a flexible connecting means, and adjacent filter plates may also be connected to one another by means of the flexible connecting means.

Preferably the flexible connecting means may be in the form of a chain.

The backing arrangement may be displaced relative to the support frame by means of a chain drive that includes an electric motor and an endless chain connected to the backing arrangement, and more particularly to the first backing plate.

According to a further aspect of the invention the filter plates may include rollers extending outwardly from sides thereof, the rollers being configured to engage tracks provided on the support frame.

The backing plates may also include rollers, the rollers being configured to locate on an upper surface of the support frame.

### BRIEF DESCRIPTION OF THE DRAWINGS

A preferred embodiment of the invention is described by way of a non-limiting example, and with reference to the accompanying drawings in which:

FIG. 1 is a perspective view of the filter press in accordance with the invention, with the filter plates being in an operative position;

FIG. 2 is a perspective view of part of the filter press of FIG. 1 without the cleaning device, and with the filter plates being spaced part in an inoperative position;

FIG. 3 is a perspective view of the filter press of FIG. 2, with the backing arrangement and filter plates being partially displaced towards the operative position;

FIG. 4 is a perspective view of the filter press of FIG. 2, with the filter plates abutting one another, but without a sealing force being imparted thereon;

FIG. 5 is a perspective view of the filter press of FIG. 2, with the filter plates abutting one another, and wherein the backing arrangement is locked relative to the support frame;

FIG. 6 is a perspective view of the filter press of FIG. 2, with the filter plates in an operative position wherein the backing arrangement imparts a sealing force on the filter plates;

FIG. 7 is a perspective view of the filter press of FIG. 2, with the filter plates being in an inoperative position, and being tilted to a first angularly displaced position;

FIG. 8 is a perspective view of the filter press of FIG. 7, wherein the filter plates are tilted to a second angularly displaced position;

FIG. 9 is a side view of the filter press of FIG. 1, wherein the cleaning device is in an inoperative, raised position;

FIG. 10 is a side view of the filter press of FIG. 9, wherein the cleaning device is lowered between the filter plates;

FIG. 11 shows the drive means used to tilt the filter plates as shown in FIGS. 7 and 8; and

FIG. 12 is a perspective view of the backing arrangement and some of the filter plates.

FIG. 13 is a perspective view of the filter plates of FIG. 12.

### DETAILED DESCRIPTION OF THE INVENTION

Referring to the drawings, in which like numerals indicate like features, a non-limiting example of a filter press in accordance with the invention is indicated by reference numeral 10. The filter press 10 includes a supporting frame 12 that carries a filter pack 20 and a backing arrangement 30. A cleaning device 60 extends upwardly from the support frame 12.

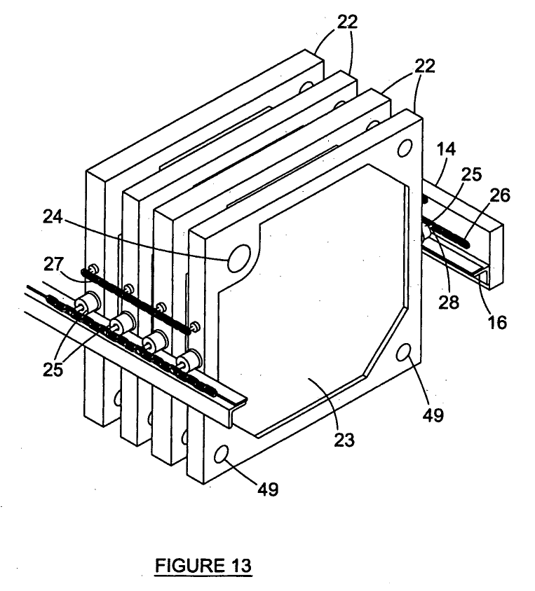

A filter pack 20 comprises a plurality of filter plates 22, and part of a filter pack 20 can best be seen in FIG. 13. Each filter plate 22 has a cavity 23 formed therein, the cavities being configured for adjacent filter plates 22 to form a filtration chamber (not shown) when they abut. The filter plates 22 also include internal inlet conduits 24 for feeding slurry into the filtration cavities, and internal outlet conduits 49 for discharging solid-free filtrate from the filtration cavities. Filter cloths (not shown), adapted to allow permeation of liquids therethrough, separate the filtration cavities from the internal outlet conduits 49.

A pair of rollers 25 extends from the sides of each filter plate 22. The rollers 25 are configured to engage tracks 16 provided on rails 14 extending along the length of the support frame 12. Adjacent filter plates 22 are connected by means of flexible connecting members in the form of displacement chains 26, which are used to pull the filter plates 22 apart. The displacement chain 26 is connected to shafts 28 extending beyond the rollers 25. A further flexible connecting means in the form of a tilting chain 27 extends between adjacent filter plates 22. The tilting chain 27 is connected to protrusions 29 extending from sides of the filter plates, which protrusions are located offset relative to a centerline of the filter plates 22 so as to be located in an operatively upper half of the filter plates. This configuration aids in facilitating a tilting action when a force is exerted on the tilting chain 27.

In the particular embodiment described hereinbefore, the filter pack 20 is made up of chamber filter plates 22. It will however be appreciated that the invention is not limited to the use of chamber filter plates, and that membrane filter plates (not shown), or a mix between membrane and chamber filter plates, may also be utilized.

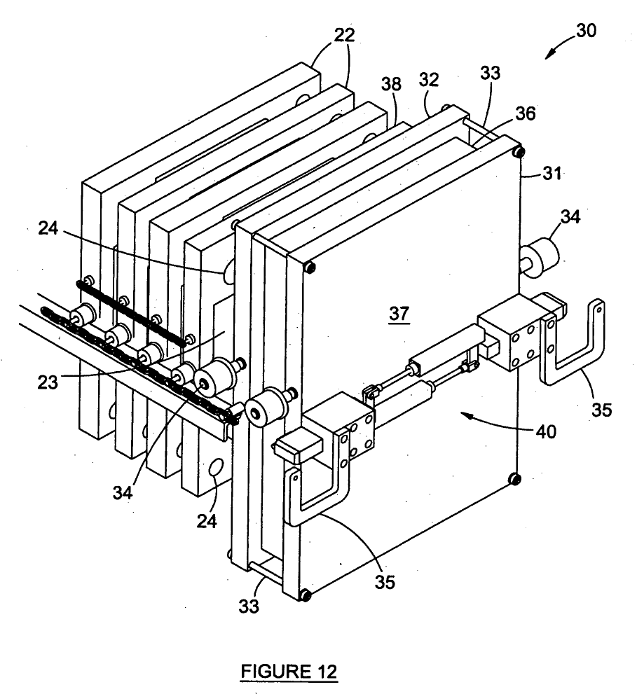

A backing arrangement 30 is located on the support frame 12 adjacent the outermost filter plate 38 of the filter pack 20. Referring to FIG. 12, the backing arrangement comprises a first backing plate 31, a second backing plate 32, and a pressure exerting mechanism in the form of a pressurizable bladder 36 sandwiched between the first 31 and second 32 backing plates. Each of the backing plates, 31 and 32, has a pair of opposing rollers 34 that extend from opposite sides thereof. The rollers 34 are configured to engage upper surfaces 17 of the rails 14 that extend along the length of the support frame 12. The backing plates, 31 and 32, are slideably connected to one another by means of rods 33 that engage apertures (not shown) provided in corners of the backing plates, 31 and 32. The pressurizable bladder 36 is located between the two backing plates, 31 and 32, and is in flow communication with a pressurization fluid. When the bladder 36 is pressurized, the second backing plate 32 is displaced away from the first backing plate 31 due to the backing plates being slideably connected.

The bladder 36 may be made from reinforced plastic or rubber. In the particular example the bladder has a pressure rating of 20 bar, and may expand up to 100 mm when pressurized.

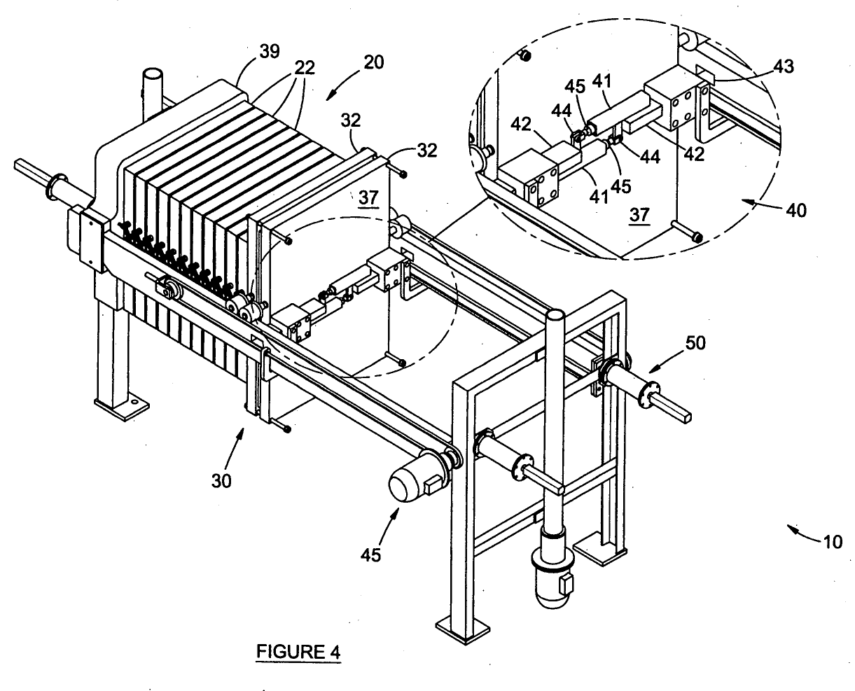

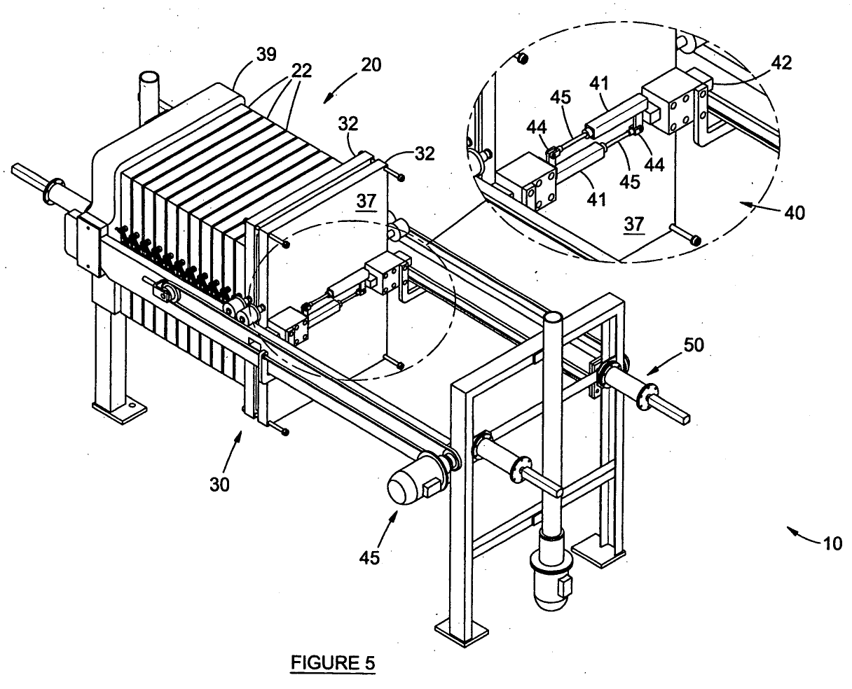

The first backing plate 31 also includes a locking mechanism 40 for use in locking the position of the first backing plate 31 relative to the rails 14 and thus the support frame 12. The locking mechanism 40, as seen in FIGS. 4 and 5, includes pistons 41 that are mounted on an outer surface 37 of the first backing plate 31. Ends 44 of the piston rods 45 are connected to locking members in the form of bolts 42 that are slideably mounted to the outer surface 37 of the first backing plate 31. The bolts 42 can be displaced to extend beyond a periphery of the first backing plate 31 so as to engage locking apertures 43 in the rails 14 of the supporting frame 12. When the bolts 42 engage such apertures 43 the first backing plate 31 is securely locked to the supporting frame in a fixed position.

The filter press also includes a stationary backing plate 39 at an end of the filter pack 20 opposite the backing arrangement 30. The filter pack 20 as a unit is therefore sandwiched between the stationary backing plate 39 and the backing arrangement 30.

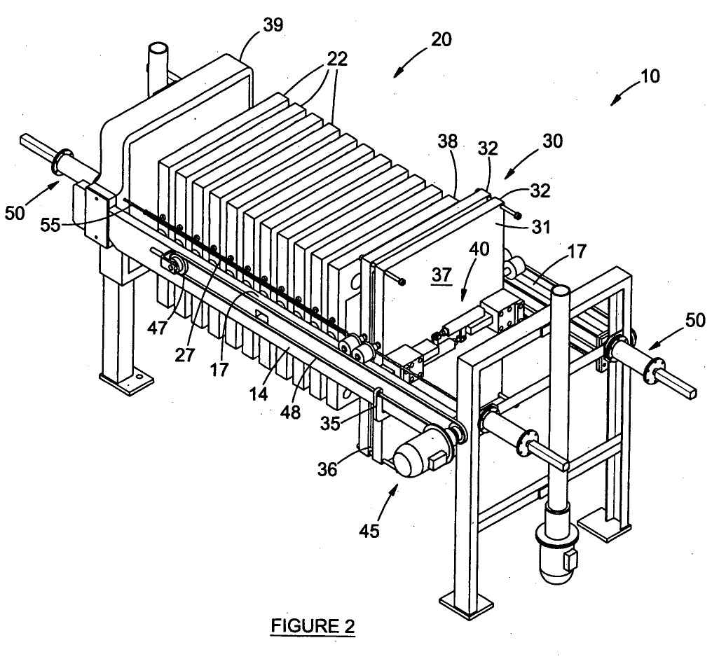

Drive means 45 in the form of a chain drive is provided for driving the backing arrangement 30, and thus also indirectly the filter plates 22. The drive means 45, as shown in FIG. 2, includes an electric motor 46, a set of pulleys 47, and an endless chain 48 rotating about the pulleys 47. The electric motor 46 is connected to the chain 48 by though a suitable gearbox (not shown). A bracket 35 extends from the first backing plate 31 and is connected to the endless chain 48 so that rotation of the electric motor 46 causes the first backing plate 31, and therefore the complete backing arrangement 30, to be displaced along the rails 14. The electric motor 46 is bi-directional so that the backing arrangement 30 can be displaced both towards and away from the stationary backing plate 39.

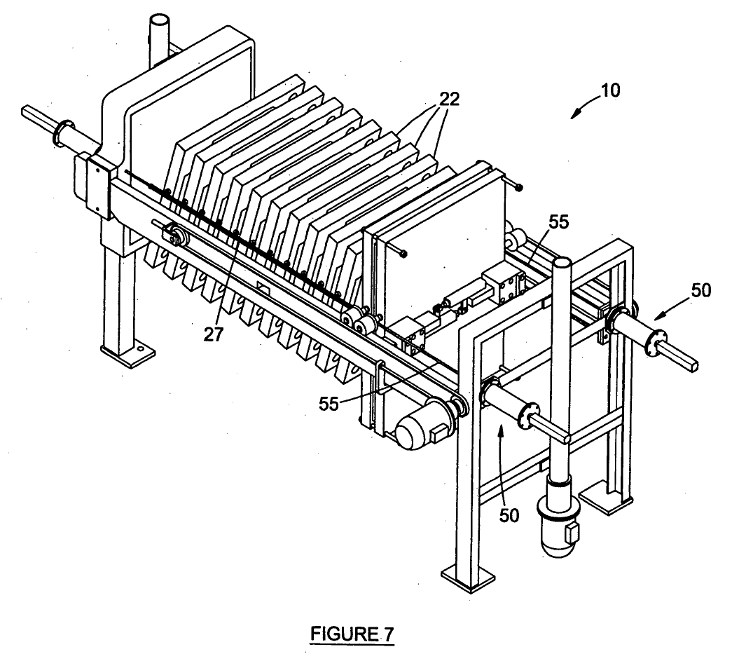

The filter press 10 further includes a filter plate 22 actuating device in the form of a tilting mechanism 50, which is shown in FIGS. 7, 8 and 11. The tilting mechanism 50 comprises a piston assembly 52 being connectable to the tilting chains 27 on the filter plates 22 by means of a tilting cable 55. The piston arrangement 52 has an electromagnet 54 located at the end of a piston rod 53. The tilting cable 55 terminates in an end section 56 made from a magnetic material. A flange 57 is provided for connecting the tilting mechanism 50 to the support frame 12. In the described embodiment a pair of tilting mechanisms 50 is provided on each side of the support frame 12.

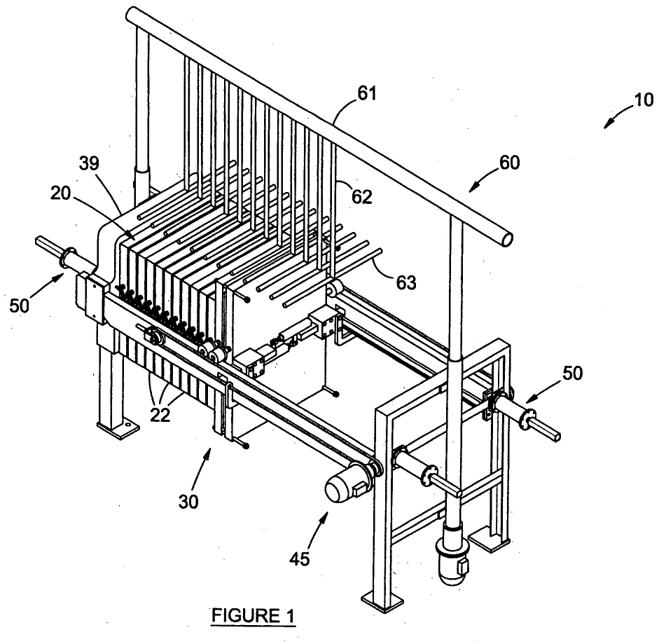

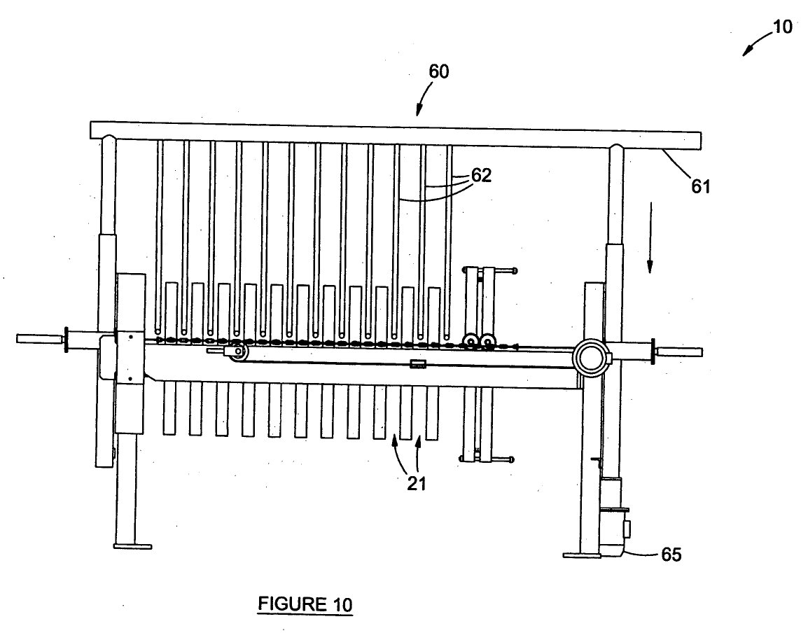

A cleaning device 60, shown in FIGS. 1, 9 and 10, is located above the filter press 10, and extends upwardly from the support frame 12. The cleaning device 60 is in the form of a water spraying device, and is used to clean the filter cloths (not shown) as well as the filter plates 22 when the filter pack 20 is in an inoperative position and the filter plates 22 are spaced apart. The cleaning device 60 includes a header 61, which is connected to a water supply source (not shown). The header 61 branches off into a plurality of T-shaped branches 62 having apertures in sides of horizontal sections 63 thereof. The branches 62, and more particularly the horizontal sections 63, are configured and dimensioned to fit in the gaps 21 between the spaced apart filter plates 22 when the filter pack 10 is in an inoperative position. The apertures are sideways orientated so as to direct fluid flow towards the filter plates 22 when located there between. The cleaning device 60 is moveable relative to the support frame 12, and is moved up and down by means of an electrical motor 65.

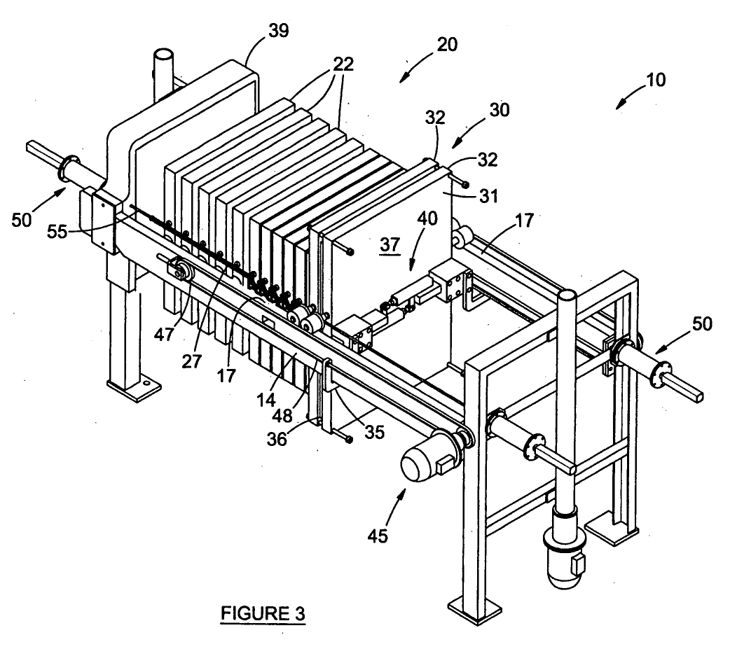

The operation of the press filter 10 is described with reference to FIGS. 2 to 10. In FIG. 2 the press filter 10 is shown with the filter pack 20 in an inoperative positions so that adjacent filter plates 22 are spaced apart to form gaps 21. The backing arrangement 30 is located towards an end of the support frame 12, and the bladder 36 is in a deflated position. When the chain drive 45 is activated, the electric motor 46 moves the backing arrangement 30 towards the stationary backing plate 39, and thus also towards the filter plates 22. Upon continued movement the second backing plate 32 engages the outermost filter plate 38, which in turn engages an adjacent filter plate 22 until all the filter plates are in close abutment as shown in FIG. 4. At this stage the force imparted by the chain drive 45 onto the backing arrangement 30 and thus the filter pack 20, is insufficient to provide a proper seal between adjacent filter plates 22.

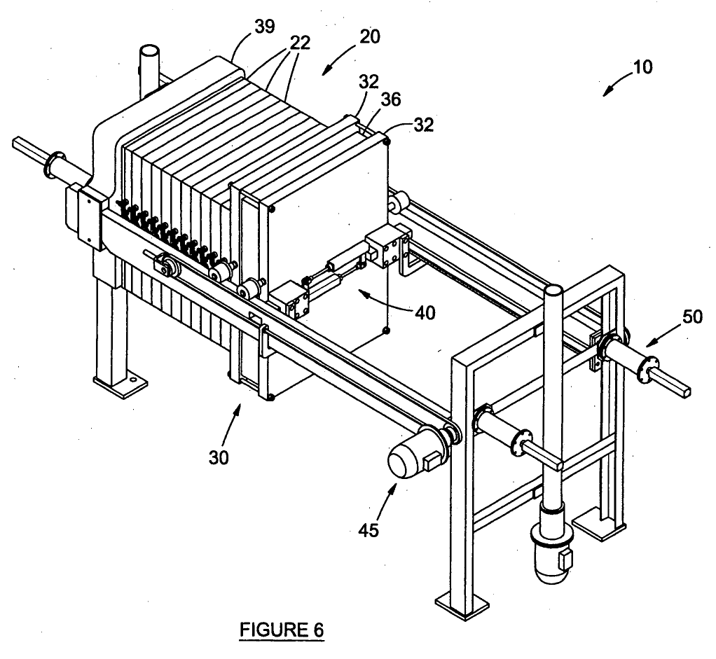

The first backing plate 31 is now locked into position by actuating the locking mechanism 45 as shown in FIG. 5. Once the first backing plate 31 is locked into position, the filter pack 20 is effectively sandwiched between two stationary backing plates, being the first backing plate 31 and the stationary backing plate 39. The bladder 36 can now be inflated by pressurization as shown in FIG. 6. As the bladder 36 expands, the second backing plate 32 is forced away from the first backing plate 31 towards the filter plates 22, due to the first backing plate 31 being securely locked in a stationary position. The second backing plate 32 therefore imparts a closing force on the outermost filter plate 38 which is transferred to the rest of the filter plates 22 so as to bring them all in sealing abutment, thus rendering the filter pack 20 operative. The filtration process subsequently commences, and occurs in a manner similar to the prior art.

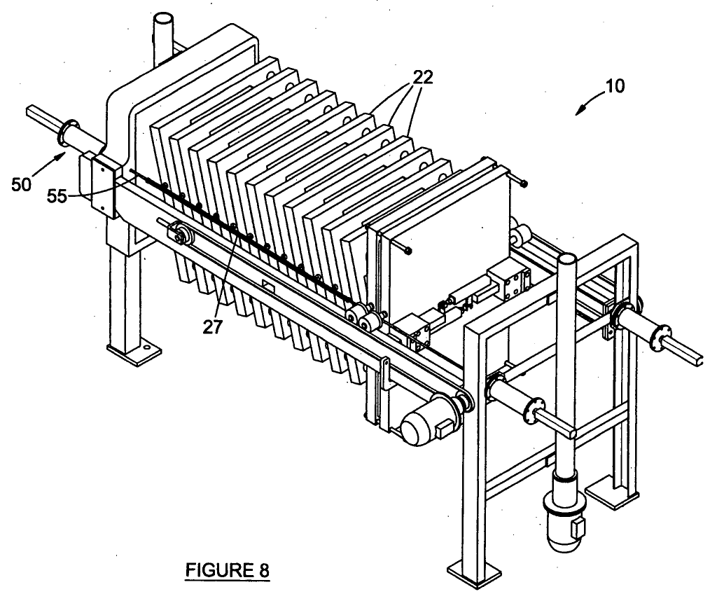

Once filtration has been completed, and a densely packed filter cake has been formed, the above operation is performed in reverse to return the press filter 10 to the position as shown in FIG. 2. Once the filter plates 22 are spaced apart as shown in FIG. 2, the filter cakes (not shown) must be removed. The filter cakes should in principle be automatically discharged under gravity, but experience has shown that the filter cakes often remain stuck in the cavities in the filter plates 22. To resolve this problem, the tilting mechanism 50 is now put in operation in order to tilt the filter plates 22 between the orientations as shown in FIGS. 7 and 8. This tilting action assists in releasing the filter cakes from the filter plates 22.

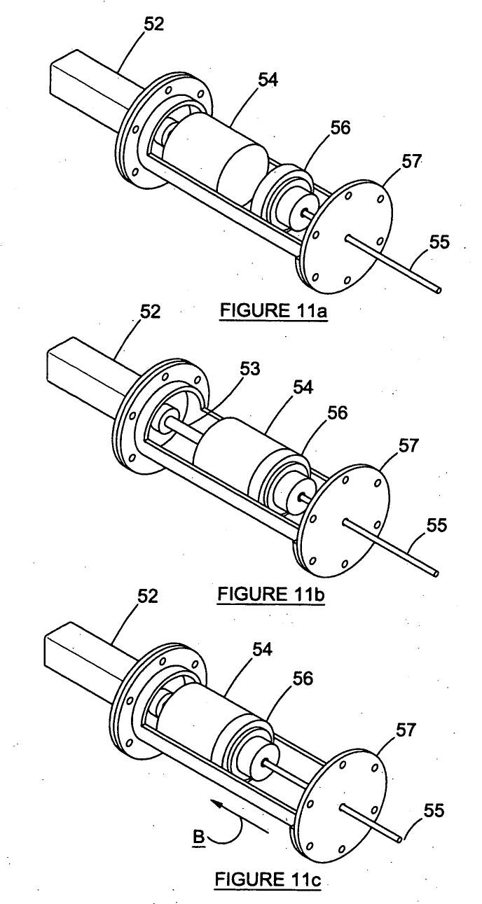

The operation of the tilting mechanism 50 is shown in FIG. 11a to 11c. In FIG. 11a the piston 52, and thus the electromagnet 54 located at an end of the piston rod 53, is disconnected from the magnetic end section 56 of the tilting cable 55. When the piston 52 is actuated, the electromagnet 54 is forced into abutment with the magnetic end section 56. Once the electromagnet 54 and the magnetic end section 56 abut, the electromagnet is energized so as to securely connect to the magnetic end section 56. When the piston rod 53 is subsequently returned to the starting position as shown in FIG. 11c, the tilting cable is 55 drawn towards the piston, in the direction indicated by arrow B, in order to tilt the filter plates 22 to which it is connected.

The filter plates 22 are first tilted in one direction and thereafter in an opposite direction. This is done by the sequential operation of the tilting mechanisms 50 on opposing ends of the support frame 12. This back and forth filter plate 22 movement causes the filter cakes (not shown) to become dislodged from the cavities 23 in the filter plates 22, and also from the filter cloth (not shown) to which it may be stuck. Importantly, the filter plates 22 are interconnected by means of the tilting chain 27 that connects adjacent filter plates 22. When the tilting mechanisms 50 are actuated the filter plates 22 tilt simultaneously as shown in FIGS. 7 and 8.

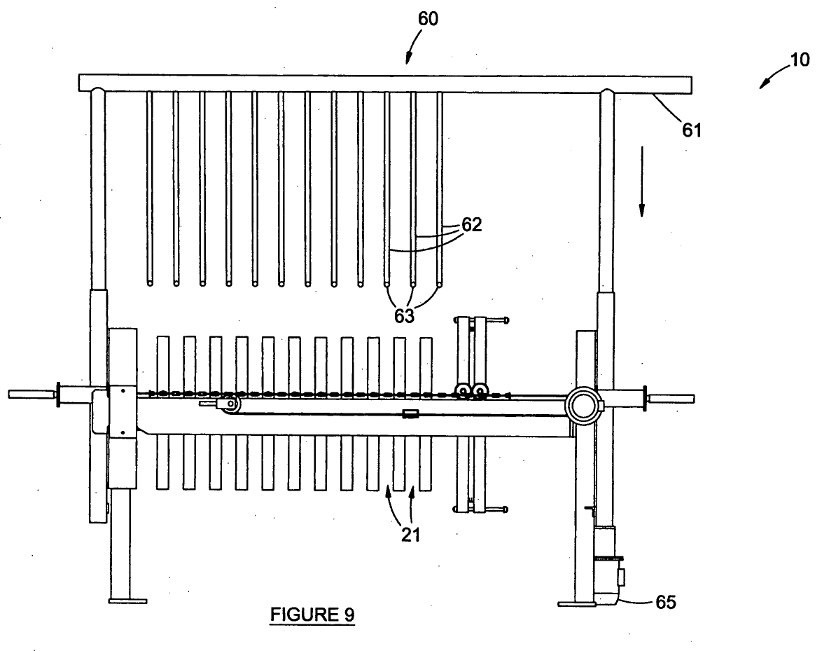

After the filter cakes have been removed from the filter plates 22, the filter plates 22 and more importantly the filter cloths (not shown) lining the filter plates 22, can be cleaned using the cleaning device 60. The filter plates 22 are first returned to a spaced apart, vertically orientated position shown in FIG. 9. The cleaning device 60 is subsequently lowered by the electrical motor 65 so that the branches 62 extending from the header 61 of the cleaning device 60 enters the gaps 21 between adjacent, spaced apart filter plates 22. Water, or any other suitable cleaning liquid, is pumped into the header at a high pressure, and subsequently discharged through the apertures in the horizontal sections 63 of the branches 62 in order for water jets to impinge on the filter cloth and filter plates 22 at high velocity to clean the same. The cleaning device 60 is adapted to travel along the full height of the filter plates 22 so as to clean the full face of each filter cloth (not shown) and filter plate 22.

It will be appreciated that the above is only one embodiment of the invention, and that there may be many variations in detail without departing from the spirit and scope of the invention. The pressure exerting mechanism may for instance be located on an outer side of the stationary backing plate 39, and engagement means may be provided for pulling the filter plates together as opposed to pushing them together. Also, the pressure exerting mechanism may not be a pressure cell or pressurizable bladder, but may be some other form of pressure exerting mechanism mounted on the displaceable and lockable backing arrangement described in the specification.

1. A filter press comprising:
a support frame;
a plurality of filter plates mounted adjacent one another on the support frame,
the filter plates being displaceable between an inoperative position wherein adjacent filter plates are spaced apart, and an operative position wherein adjacent filter plates abut to form filtration cavities between abutting filter plates;
a backing arrangement located adjacent an outermost filter plate,
the backing arrangement being displaceable relative to the support frame and being releasably lockable in a fixed position relative to the support frame; and
a pressure exerting mechanism adapted to force the filter plates in co-operation with the backing arrangement into sealing abutment when the filter plates are in an operative position and the backing arrangement is releasably locked relative to the support frame.

2. The filter press according to claim 1 wherein the pressure exerting mechanism is a pressure cell.

3. The filter press according to claim 2 wherein the pressure exerting mechanism is a one or more pressurizable bladders.

4. The filter press according to claim 3 wherein the pressurizable bladder or bladders comprise a flexible container of reinforced plastic or rubber adapted to be pressurized hydraulically or pneumatically.

5. The filter press according to any one of claims 1 to 4 wherein the backing arrangement comprises a first backing plate and a second backing plate with the pressure exerting mechanism being sandwiched between the first backing plate and the second backing plate.

6. The filter press according to claim 5 wherein the first backing plate is releasably lockable to the support frame, and the second backing plate is moveable relative to the first backing plate so that the second backing plate is forced away from the first backing plate when the pressure exerting mechanism is pressurized, so as to exert a force on the filter plates to move and hold the filter plates to and in the operative position.

7. The filter press according to claim 6 wherein the cross sectional area of the first and second backing plates and that of the pressure exerting mechanism are of similar size or larger than the cross sectional area of the filtration cavities formed by abutting filter plates.

8. The filter press according to claim 6 or claim 7 wherein the first backing plate is releasably locked to the support frame by means of a locking member which is laterally movably connected to the first backing plate for engaging an aperture provided in the support frame.

9. The filter press according to claim 6 or claim 7 wherein the first backing plate is releasably locked to the support frame by means of a locking member which is laterally movably connected to the support frame for engaging an aperture provided in the first backing plate.

10. The filter press according to claim 8 or claim 9 wherein the locking member is in the form of a bolt.

11. The filter press according to any one of claims 8 to 10 wherein the locking member is movable between a locked position and an unlocked position by means of a piston and cylinder arrangement.

12. The filter press according to any one of claims 1 to 11 wherein the backing arrangement is connected to the filter plates in order for the filter plates to be displaced when the backing arrangement is displaced relative to the support frame.

13. The filter press according to claim 12 wherein the backing arrangement is connected to the outermost filter plate by means of a flexible connecting means and adjacent filter plates are connected to one another by means of such flexible connecting means.

14. The filter press according to claim 13 wherein the flexible connecting means is in the form of a chain.

15. The filter press according to any one of claims 12 to 14 wherein the backing arrangement is displaced relative to the support frame by means of a chain drive that includes an electric motor and an endless chain connected to the backing arrangement.

16. The filter press according to any one of claims 1 to 15 wherein the filter plate include rollers extending outwardly from the sides thereof, the rollers being configured to engage tracks provided on the support frame.

17. The filter press according to any one of claims 1 to 16 wherein the backing arrangement includes rollers, the rollers being configured to locate on an upper surface of the support frame.

18. A filter press according to claim 1, substantially as herein described and exemplified with reference to the accompanying drawings.
